(19) United States
(12) Patent Application Publication
(10) Pub. No.: US 2019/0215391 A1
(43) Pub. Date: Jul. 11, 2019

(54) LINK AND CHAIN ACCESSORY FOR AN EXPANDABLE DEVICE

(71) Applicant: POPSOCKETS LLC, Boulder, CO (US)

(72) Inventors: Randy Yang Chiang, Boulder, CO (US); Altan Nahum, Boulder, CO (US); Michael J. Kory, Boulder, CO (US); Tony L. Torrance, Boulder, CO (US)

(21) Appl. No.: 16/241,491

(22) Filed: Jan. 7, 2019

Related U.S. Application Data
(60) Provisional application No. 62/614,869, filed on Jan. 8, 2018.

(51) Int. Cl. H04M 1/04; H04M 1/02

(52) U.S. Cl. CPC H04M 1/04; H04M 1/0283

(57) ABSTRACT

An expandable device accessory including a body having a first end and a second end and is movable between an expanded configuration and a collapsed configuration. A button is coupled to the first end of the body, and a link includes a first portion and a second portion. The first portion is a platform having an opening sized to receive the second end of the body. At least the first portion and the second portion of the link is adapted to removably couple to a different link.

### FIELD OF DISCLOSURE

The present disclosure relates generally to a link for an expandable device and more particularly to a link and a chain accessory for an expandable device.

### BACKGROUND

Portable electronic devices, such as MP3 players and smart phones, are often housed in protective covers or cases in order to protect the device from damage, provide a grip for handling the device, and/or provide a stand for propping the device on a surface. However, these cases can increase the effective size of the device. Expandable devices, which may be attached directly to the portable electronic device or to the case protecting the portable electronic device, are used for a variety of functions, including propping the portable electronic device on a surface and providing an expandable grip for handling the portable electronic device. The expandable devices have decorative buttons, which may display logos, decals, symbols, or other artistic renderings.

### SUMMARY

In accordance with a first exemplary aspect, an expandable device accessory may include a body having a first end and a second end and may be movable between an expanded configuration and a collapsed configuration. A button may be coupled to the first end of the body. A link may include a first portion and a second portion and the first portion may be a platform having an opening sized to receive the second end of the body. At least the first portion and the second portion of the link may be adapted to removably couple to a different link.

In accordance with a second exemplary aspect, a chain for storing an expandable device of a portable electronic device may include a first link comprising a body arranged to couple to an expandable device. The body may include a collar extending from a surface of the body. A second link may be removably coupled to the body of the first link and may include a body defining an aperture sized to receive the collar of the first link. The second link may be coupled to the body of the first link when the collar of the first link extends through the aperture of the second link. The first link may rotate relative to the second link when the first link is coupled to the second link.

In accordance with a third exemplary aspect, a chain accessory for holding expandable devices may include a first link comprising a platform, a connector, and a bridge connecting the connector and the platform. The platform may include a top surface, a bottom surface, and a collar extending away from the top surface. A second link may include a platform, a connector, and a bridge connecting the connector and the platform. The connector of the second link may include an aperture sized to receive the collar of the platform of the first link. The first link may be coupled to the second link when the collar of the first link is disposed in the aperture of the connector of the second link.

In further accordance with any one or more of the foregoing first, second, or third exemplary aspects, an expandable device accessory and/or a chain accessory may further include any one or more of the following preferred forms.

In a preferred form, the second portion of the link may be a connector adapted to removably couple to a platform of a different link.

In a preferred form, the connector may have an aperture sized to receive a portion of the platform of the different link.

In a preferred form, a collar may project from a surface of the platform, and the collar may define the opening of the platform.

In a preferred form, the collar may be sized to extend into an aperture of a connector of a different link.

In a preferred form, a bridge may connect the first portion and the second portion.

In a preferred form, the bridge may define a curved surface adapted to fit against a curved surface of a connector of a different link.

In a preferred form, the second portion of the link may be a second platform including a collar and an opening sized to receive the second end of the body.

In a preferred form, a locking member may attach to the second end of the body.

In a preferred form, the locking member may removably couple to the opening of the platform.

In a preferred form, the locking member may slidably couple to the opening of the platform.

In a preferred form, the locking member may rotatably couple to the opening of the platform.

In a preferred form, a second link may include a first portion and a second portion.

In a preferred form, the first portion of the second link may be a platform having an opening sized to receive the second end of the body.

In a preferred form, the first portion of the second link may removably couple to the platform of the link.

In a preferred form, a first surface of the first portion may lie on a first plane and a first surface of the second portion may lie on a second plane different from the first plane.

In a preferred form, the second link may be identical to the link.

In a preferred form, the first link may include a second collar extending from the surface of the body.

In a preferred form, the body of the first link may include an aperture sized to receive a collar of a different link.

In a preferred form, the body of the first link may have a figure-eight shape.

In a preferred form, the body of the first link may be triangular.

In a preferred form, the body of the first link may be L-shaped.

In a preferred form, the body of the first link may have a T-shape.

In a preferred form, the chain accessory may include a third link having a platform.

In a preferred form, the platform of the third link may be coupled to the connector of the first link.

In a preferred form, the first link may include a second connector sized to receive a collar of the platform of the second link.

In a preferred form, the first link may include a second platform adapted to couple to the connector of the second link.

In a preferred form, the first link and the second link may couple by snap-fit connection.

In a preferred form, the first link and the second link may couple by interference fit.

### BRIEF DESCRIPTION OF THE DRAWINGS

FIG. 1 is a top view of a first exemplary link, an expandable device, and a first exemplary chain accessory having a plurality of connected links assembled in accordance with the teachings of the present disclosure;

FIG. 2 is a top view of the first exemplary link of FIG. 1;

FIG. 3 is a cross-sectional side view of the link of FIG. 2 taken at A-A;

FIG. 4 is a top view of a second exemplary chain accessory composed of two links and assembled in accordance with the teachings of the present disclosure;

FIG. 5 is a side view of the chain accessory of FIG. 4;

FIG. 6 is a side view an exemplary expandable device adjacent to the chain accessory of FIG. 4, and showing the expandable device in the exploded configuration;

FIG. 7 is a cross-sectional side view of the expandable device and chain accessory of FIG. 6 showing the expandable device coupled to a link of the chain accessory;

FIG. 8 is a cross-sectional side view of the expandable device and chain accessory of FIG. 7 showing the expandable device is in a collapsed configuration;

FIG. 9 is a top view of a second exemplary link assembled in accordance with the teachings of the present disclosure;

FIG. 10 is a top view of a third exemplary chain accessory including the link of FIG. 9 connected to two other links and are assembled in accordance with the teachings of the present disclosure;

FIG. 11 is a top view of a third exemplary link assembled in accordance with the teachings of the present disclosure;

FIG. 12 is a top view of a fourth exemplary link assembled in accordance with the teachings of the present disclosure;

FIG. 13 is a top view of a fifth exemplary link assembled in accordance with the teachings of the present disclosure;

FIG. 14 is a top view of a fourth exemplary chain accessory including the first exemplary link of FIG. 2, the second exemplary link of FIG. 9, the third exemplary link of FIG. 11, the fourth exemplary link of FIG. 12, and the fifth exemplary link of FIG. 13 assembled in accordance with the teachings of the present disclosure;

FIG. 15 is an isometric view of a first exemplary expandable device constructed in accordance with the teachings of the present disclosure;

FIG. 16 is an exploded view of the expandable device of FIG. 15, including a first exemplary button, a first exemplary body including a first exemplary disk, a first exemplary hub, and a first exemplary platform;

FIG. 17 is a front, cross-sectional view of the expandable device taken at I-I of FIG. 15;

FIG. 18 is a side, cross-sectional view of the expandable device taken at II-II of FIG. 15;

FIG. 19 is a front, cross-sectional view of the expandable device of FIG. 15 in a collapsed configuration;

FIG. 20 is a bottom view of the button of FIG. 15;

FIG. 21 is a top view of the connecting disk of FIG. 15;

FIG. 22 is a side view of the connecting disk of FIG. 21;

FIG. 23 is a isometric view of the hub of FIG. 15;

FIG. 24 is a bottom view of the hub of FIG. 23;

FIG. 25 is a top view of the platform of FIG. 15;

FIG. 26 is a side, cross-sectional view of the platform taken at III-III of FIG. 25;

FIG. 27 is a front, cross-sectional view of the platform taken at IV-IV of FIG. 25;

FIG. 28 is a front, cross-sectional view of a second exemplary expandable device constructed in accordance with the teachings of the present disclosure;

FIG. 29 is a side, cross-sectional view of the expandable device of FIG. 28; and

FIG. 30 is a top view of a second exemplary connector of the expandable device of FIG. 28.

### DETAILED DESCRIPTION

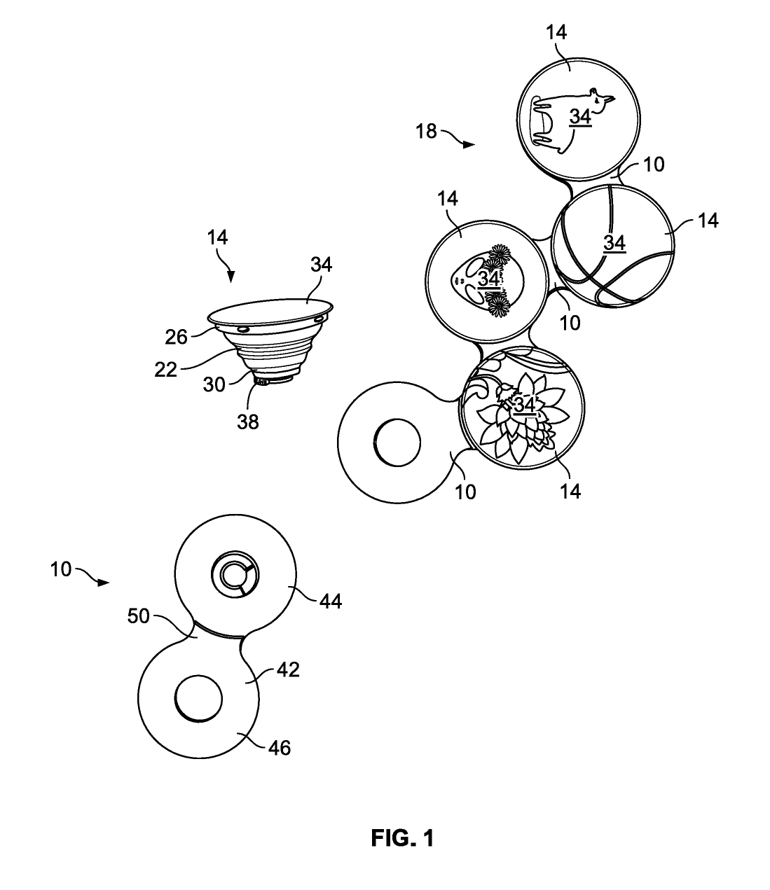

According to one or more examples of the present disclosure, a modular link 10 constructed according to the teachings of the present disclosure may permit a user to store, package, and creatively display one or more expandable devices 14. The link 10 is configured to removably receive the expandable device 14 and also connect to another link 10, which may be the same or different, to form a chain accessory 18. For example, FIG. 1 illustrates a first exemplary link 10, an expandable socket device 14, and an example chain accessory 18 formed when multiple links 10 are coupled together. A user may store multiple expandable devices 14, such as the expandable device 14 in FIG. 1, by attaching multiple expandable devices 14 in a connected decorative chain accessory 18. The exemplary links 10 disclosed herein may be configured to removably lock to any number of expandable devices 14. In some instances, the expandable device 14 of the current disclosure may be in the form of a commercially available grip and stand product such as that available on www.popsockets.com. For example, U.S. Pat. No. 8,560,031, filed on Feb. 23, 2012; U.S. Pat. No. 9,970,589, filed on Nov. 9, 2017; U.S. Pat. No. 10,019,034, filed Dec. 31, 2014; U.S. Pat. No. 10,054,259, filed on Jun. 7, 2017; U.S. Pat. No. 10,030,807, filed on Mar. 15, 2018; U.S. application Ser. No. 15/679,934, filed on Aug. 17, 2017; U.S. application Ser. No. 15/729,260, filed on Oct. 10, 2017; U.S. application Ser. No. 15/803,410, filed on Nov. 3, 2017; U.S. application Ser. No. 15/808,076, filed on Nov. 9, 2017; U.S. application Ser. No. 15/864,402, filed on Jan. 8, 2018; U.S. application Ser. No. 15/864,509, filed on Jan. 8, 2018; U.S. application Ser. No. 15/906,920, filed on Feb. 27, 2018; U.S. application Ser. No. 15/952,025, filed on Apr. 12, 2018; U.S. application Ser. No. 15/993,458, filed on May 30, 2018; and U.S. application Ser. No. 16/001,723, filed on Jun. 6, 2018 each describes suitable expandable grip and stand product, which also incorporates collapsible mechanisms, the entirety of each being hereby incorporated by reference.

In the illustrated example, the expandable device 14 includes a body 22 configured to collapse and expand and has a first end 26 and a second end 30 opposite the first end 26. The device 14 includes a button 34 coupled to the first end 26 of the body 22, and a locking member 38 connected to the second end 30 of the body 22. The button 34 may be coupled via sonic welding, glue, or other adhesive. Alternatively, the button 34 may be removably coupled to the body 22. The locking member 38 is attachable to a platform accessory of a portable device or a case for a portable device (not shown) when the device 14 is in use. The locking member 38 of the expandable device 14 may attach to the link 10 in the same or similar way as the expandable device 14 attaches to the platform accessory to store the expandable device when not in use. For example, the locking member 38 removably couples to the link 10 (e.g., by sliding, rotating, or push-fitting). When multiple links 10 are connected, the chain 18 can store and display multiple expandable devices. The chain 18 is constructed of two or more overlapping links 10.

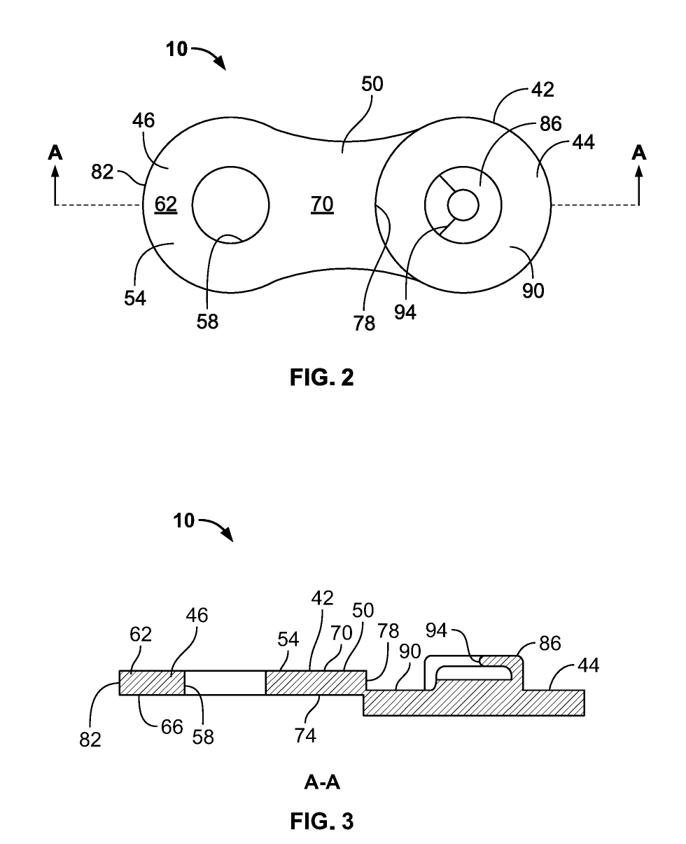

As shown in FIGS. 1 through 3, the link 10 has a figure-eight shaped body 42 with a platform portion 44, a connector portion 46, and a bridge 50 connecting the platform 44 and the connector 46. Turning to FIGS. 2 and 3, the connector 44 in the illustrated example has a round-shaped base 54 and an aperture 58 formed in the base 54. The bridge 50 extends from the base 54 of the connector 46 such that a top surface 62 and a bottom surface 66 of the connector 46 is coplanar with a top surface 70 and a bottom surface 74 of the bridge 50, respectively. The bridge 50 includes a curved side 78 that is shaped to fit smoothly against a curved outer edge 82 of a connector 46 of a different link 10. The bridge 50 connects the connector 46 to the platform 44 such that the body 42 of the link 10 is an integrated component. The platform 44 includes a collar 86 extending axially away from a top surface 90 of the platform 44. The collar 86 includes an opening 94 that is adapted to receive the second end 30 of the expandable device 14 by a releasable locking engagement (e.g., rotatably coupling, slidably coupling, press-fit coupling). In the illustrated example, the collar 86 slidably receives the second end 30 of the expandable device 14 and locks to the second end 30 of the expandable device 14 when the second end 30 of the device 14 slides and snaps into the opening 94 of the collar 86. However, in other examples, the collar 86 may removably receive the second end 30 of the expandable device 14 by other locking engagements, such as, for example, a snap-fit connection, threaded connection, or luer-lock connection.

The platform 44 of the link 10 is shaped to mate with a connector 46 of a different link 10. The collar 86 is sized to slide through the aperture 58 of a connector 46 of a different link 10 such that the opening 94 of the platform 44 extends through the top surface 62 of the connector 46 to receive an expandable device 14.

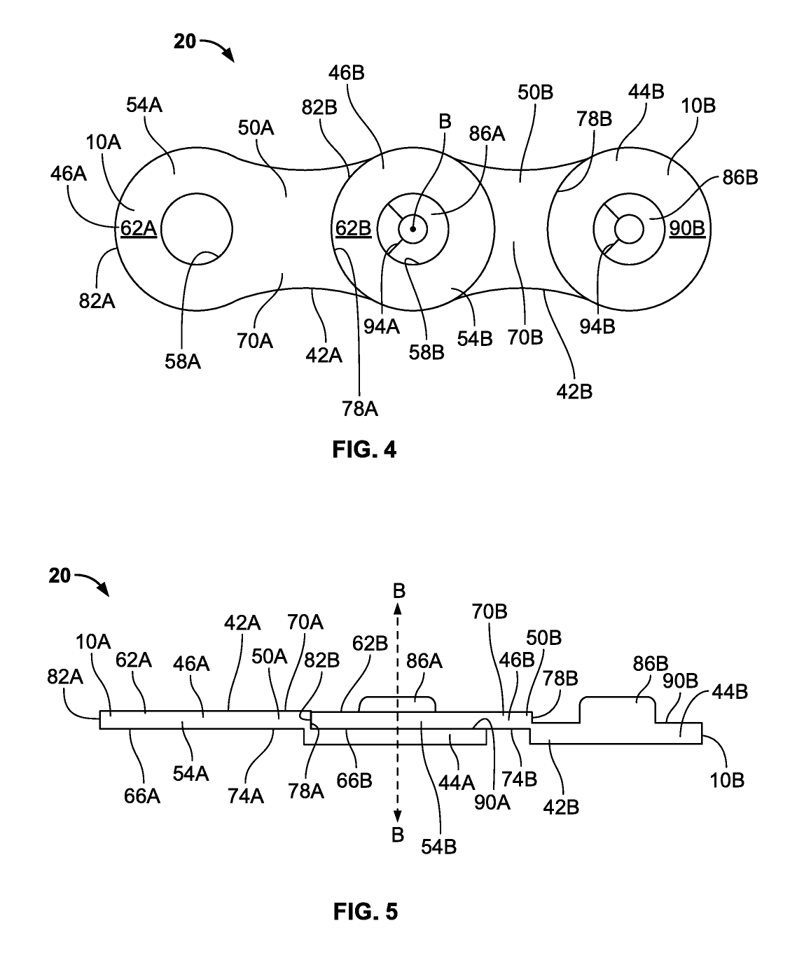

For example, in FIGS. 4 and 5 a chain accessory 20 of two identical first and second links 10A, 10B is constructed according to the teachings of the present disclosure. The first link 10A and the second link 10B are identical to each other, and are identical to the link 10 of FIGS. 1-3. Letters ‘A’ and ‘B’ are used in the following figures to differentiate the components of the first and second links 10A, 10B. As shown in FIG. 5, a bottom surface 66B of a connector 46B of the second link 10B lies flat against a top surface 90A of a platform 44A of the first link 10A when the first and second links 10A, 10B are coupled. A top surface 62A of a connector 46A of the first link 10A is coplanar with a top surface 62B of the connector 46B of the second link 10B when the first and second links 10A, 10B are coupled. A collar 86A of the platform 44A of the first link 10A couples to the connector 46B of the second link 10B when the collar 86A slides through an aperture 58B and snaps to a base 54B of the connector 46B of the second link 10B. In the illustrated example, the platform 44A of the first link 10A snaps to the connector 46B of the second link 10B when the collar 86A is pushed through the aperture 58B of the second link 10B in an overlapping arrangement. However, in other examples, the first link 10A and the second link 10B lock together when an expandable device 14 is attached to the platform 44A of the first link 10A when the connector 46B overlaps with the platform 44A. In this example, the first and second links 10A, 10B are loosely attached until the expandable device 14 couples to the platform 44A, thereby sandwiching the connector 46B of the second link 10B with the platform 44A of the first link 10A.

Once coupled together, the first and second links 10A, 10B are rotatable about a shared axis B to form angled or straight chain link accessories 18, 20 (e.g., the chain accessory 18 in FIG. 1 or the chain accessory 20 in FIG. 4). To facilitate a rotatable connection, a curved side 78A of a bridge 50A of the first link 10A is shaped to fit against a curved outer edge 82B of the connector 46B of the second link 10B. Because the curved side 78A of the bridge 50A of the first link 10A is shaped to receive the outer edge 82B of the connector piece 46B of the second link 10B, the first and second links 10A, 10B are free to rotate relative to one another about the shared axis B. The shared axis B is the longitudinal axis of the overlapping connector piece 46B of the second link 10B and the platform piece 44A of the first link 10A. In other examples, each platform 44A, 44B and connector 46A, 46B may have a different shape than what is illustrated, and may be, for example, oval, circular, polygonal, etc. Additionally, the bridge 50A, 50B may not include a side 78A, 78B that is shaped to mate with an outer edge 82A, 82B of other links 10A, 10B.

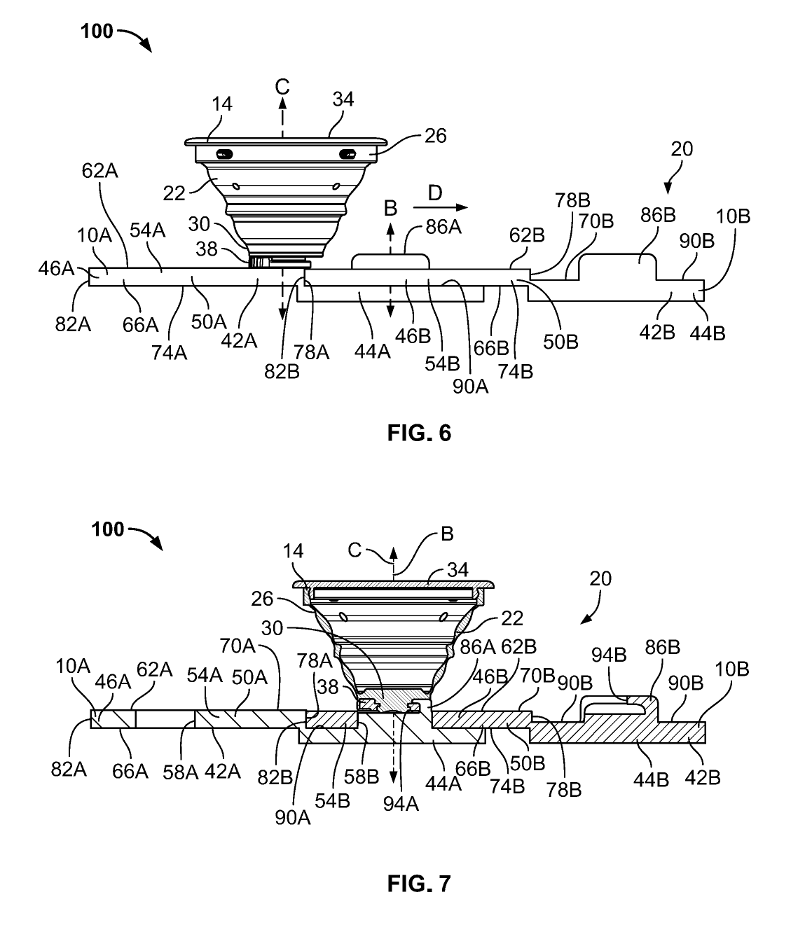

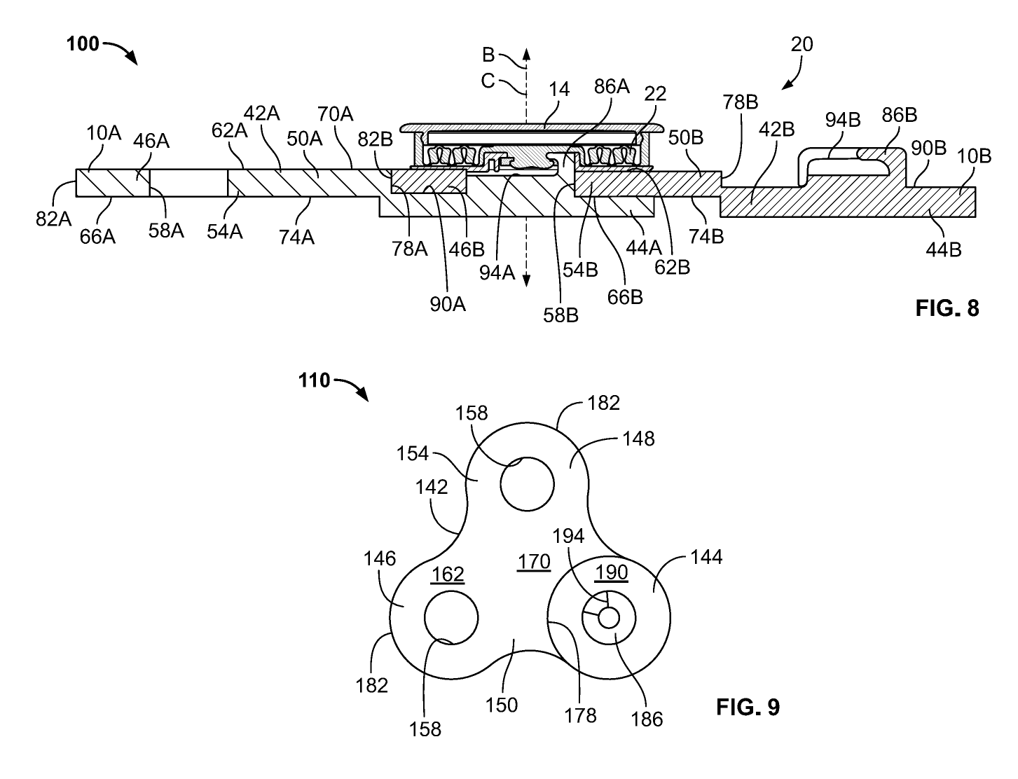

Referring now to a device and chain link assembly 100 includes the exemplary device 14 of FIG. 1 and the chain accessory 20 of the connected first and second links 10A, 10B of FIGS. 4 and 5 where the expandable device 14 is adjacent to the platform 44A of the first link 10A. The second end 30 of the expandable device 14 is above the bridge 50A of the first link 10A. To couple or lock the expandable device 14 to the chain 20, the second end 30 of the body 22 of the expandable device 12 slides in a direction D into an opening 94A formed in the collar 86A of the platform 44A of the first link 10A as shown in FIG. 7. The opening 94A formed in the collar 86A of the platform 44A is sized to receive the locking member 38 coupled to the second end 30 of the expandable device 14 such that the expandable device 14 snaps to the platform 44A when the locking member 38 is disposed in the opening 94A of the first link 10A. The expandable device 14 is configured to expand and collapse along a longitudinal axis C, which is parallel to the shared axis B of the chain 20. In the illustrated example, the expandable device 14 slides in the D direction, which is perpendicular to the longitudinal axis C of the expandable device 14 and the shared axis B of the chain 20, to couple to the platform 44A of the first link 10A. However, in other examples, the expandable device 14 may couple to the collar 86A of the platform 44A by push-fit, by rotating the expandable device 14 relative to the platform 44, or by other suitable coupling mechanisms functionally equivalent for its intended purpose. When the locking member 38 locks to the platform 44A of the first link 10A of the chain 20, the longitudinal axis C of the expandable device 14 aligns with the shared axis B of the chain 20. As shown in FIGS. 6 and 7, the expandable device 14 is coupled to the chain 20 and is in the expanded configuration. In FIG. 8, the expandable device 14 is in a collapsed configuration while coupled to the chain 20. As shown in FIG. 8, the collapsed body 22 of the expandable device 14 lies against the top surface 66B of the connector 46B of the second link 10B such that the connector 46B is sandwiched between the platform 44A of the first link 10A and the expandable device 14.

In FIG. 9, a second exemplary link 110 is constructed according to the teachings of the present disclosure. The second exemplary link 110 is similar to the first exemplary link 10 of FIGS. 1 through 3 described above, except that the second exemplary link 110 includes a platform 144, a first connector 146, and a second connector 148. Thus, for ease of reference, and to the extent possible, the same or similar components of the second exemplary link 110 will retain the same reference numbers as outlined above, although the reference numbers will increase by 100. A description of many of these elements is abbreviated or even eliminated in the interest of brevity. The second exemplary link 110 is triangular-shaped and includes the platform 144, the first connector 146, and the second connector 148 equally spaced from each other. A bridge 150 connects each of the first connector 146, the second connector 148, and the platform 144 together. The link 110 rotatably couples to an identical link 110 or to the first exemplary link 10, by sliding a collar 186 of the platform 144 through an aperture 158 of a connector 46, 146 or 148 of a different link 10, 110. In a different example, the link 110 may have a different configuration such as two platforms and one connector, three platforms, or three connectors.

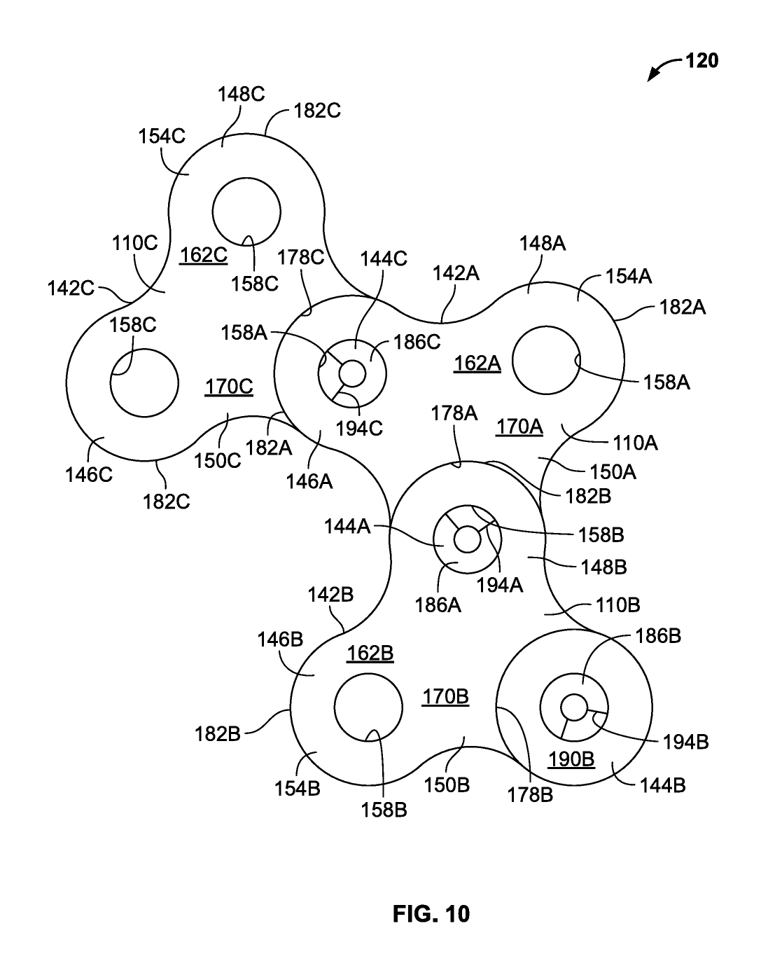

In the same or similar manner as the link 10 of FIG. 1 couples to identical or similar links, the second exemplary link 110 couples to identical or similar links. As shown in FIG. 10, a first link 110A is coupled to both a second link 1108 and a third link 110C. In particular, a platform 144A of the first link 110A is coupled to (i.e., overlapped with) a second connector 148B of the second link 1108, and a first connector 146A of the first link 110A is coupled to (i.e., overlapped with) a platform 144C of the third link 110C. A second connector 148A of the first link 110A is uncoupled (i.e., available) to couple to a platform 144 of another link 110. In the illustrated example the first link 110A is connected to two different links 1108, 110C, but may be connected to a third link via the uncoupled second connector 148A. Further, the link 110A may be coupled to the first exemplary link 10 of FIG. 1 instead of two second exemplary links 1108, 110C.

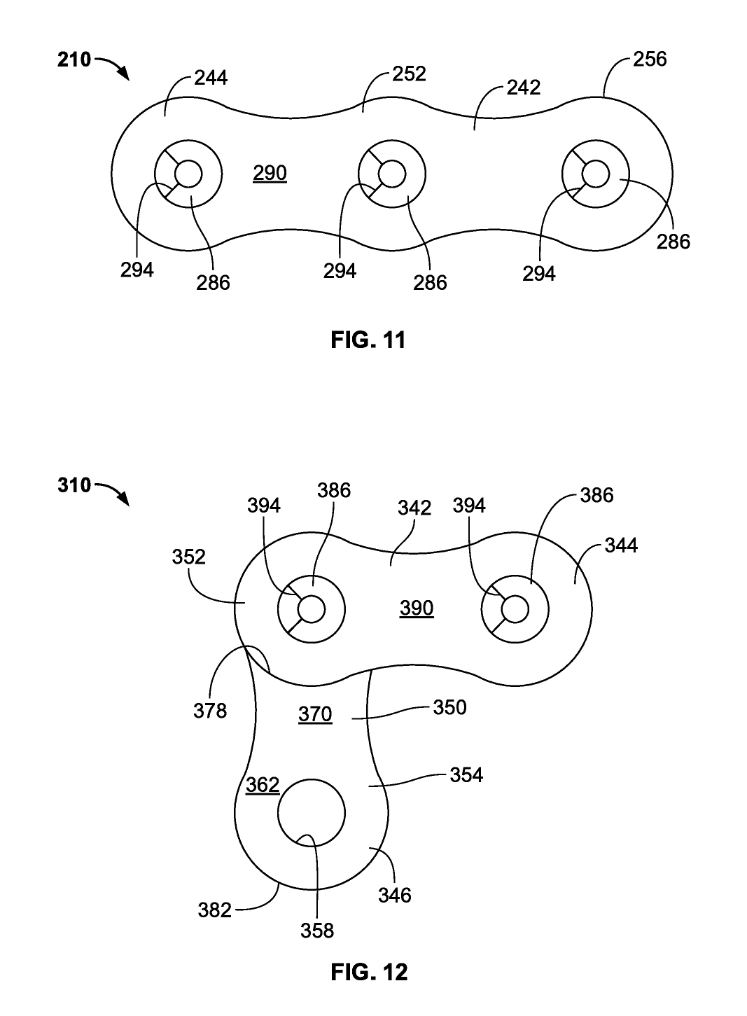

Turning now to FIG. 11, a third exemplary link 210 is constructed according to the teachings of the present disclosure. The third exemplary link 210 is similar to the second exemplary link 110 of FIG. 9 described above, except that the third exemplary link 210 includes a first platform 244, a second platform 252, and a third platform 256. Thus, for ease of reference, and to the extent possible, the same or similar components of the third exemplary link 210 will retain the same reference numbers as outlined above, although the reference numbers will increase by 100. A description of many of these elements is abbreviated or even eliminated in the interest of brevity. The third exemplary link 210 is configured to couple to an expandable device 14 at any one of the first, second, and third platforms 244, 252, 256 of the link 210. Each platform 244, 252, 256 of the link 210 is configured to receive a connector, such as the connector 46 of the first exemplary link 10 or one of the connectors 146 or 148 of the second exemplary link 110, to form a chain accessory. Each platform 244, 252, 256 of the third exemplary link 210 may overlap with the connector 46, for example, of the first exemplary link 10 by placing, for example, the first platform 244 beneath the lower surface 66 of the connector 46 and inserting the collar 286 of the platform 244 through the aperture 58 of the first link 10. By comparison to the triangular arrangement of the second exemplary link 110 of FIG. 9, the first, second, and third platforms 244, 252, 256 of the third exemplary link 210 are aligned such that a body 242 is linear. In contrast to the first exemplary link 10 and the second exemplary link 110, the third exemplary link 10 does not include a bridge that extends between each platform 244, 252, 256 of the link 210. Rather, a top surface 290 of the body 242 of the link 210 lies on one plane and a collar 286 of each platform 244, 252, and 256 lies on a different plane. In other words, the collar 286 is raised above the top surface 290 of the body 242 of the link 210.

Turning now to FIG. 12, a fourth exemplary link 310 is constructed according to the teachings of the present disclosure. The fourth exemplary link 310 is similar to the second exemplary link 110 of FIG. 9 described above, except that the fourth exemplary link 310 includes a first platform 344, a second platform 352, and a connector 346. Thus, for ease of reference, and to the extent possible, the same or similar components of the fourth exemplary link 310 will retain the same reference numbers as outlined above with respect to the second exemplary link 110, although the reference numbers will increase by 200. A description of many of these elements is abbreviated or even eliminated in the interest of brevity. By comparison to the triangular arrangement of the second exemplary link 110 of FIG. 9, the first platform 344, the second platform 352, and the connector 346 are arranged in an L-shaped configuration such that a body 342 of the link 310 forms a right angle. In this example, the second platform 352 is connected to both the connector 346 and the first platform 344. In particular, a bridge 350 connects the connector 346 to the second platform 352. However, in other examples, the connector 346 may instead be connected to the first platform 344 on one side and the second platform 352 on the other side to form the L-shaped link body 342.

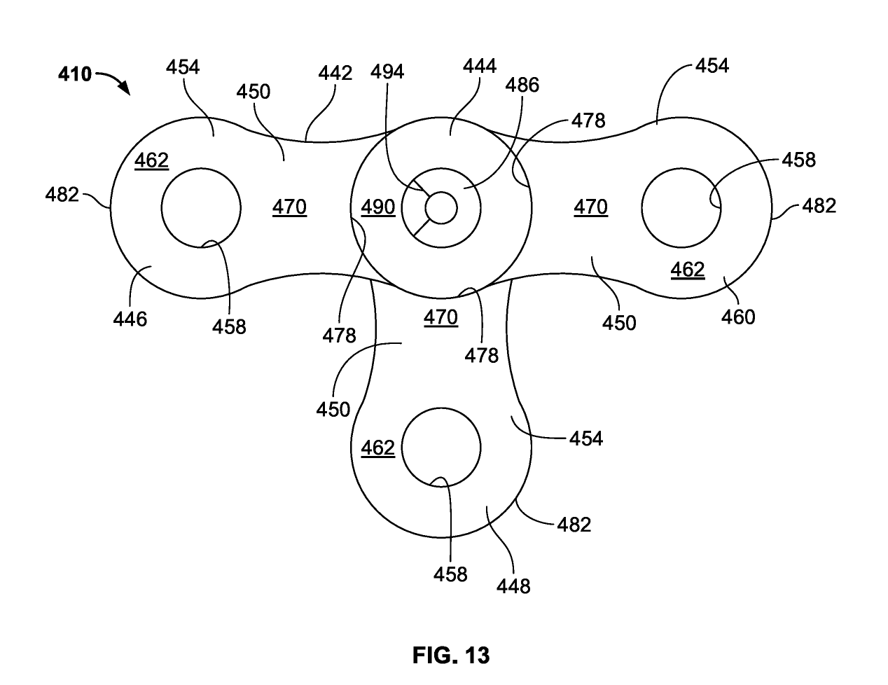

Turning now to FIG. 13, a fifth exemplary link 410 is constructed according to the teachings of the present disclosure. The fifth exemplary link 410 is similar to the fourth exemplary link 310 of FIG. 12 described above, except that the fifth exemplary link 410 includes a platform 444, a first connector 446, a second connector 448, and a third connector 460. Thus, for ease of reference, and to the extent possible, the same or similar components of the fifth exemplary link 410 will retain the same reference numbers as outlined above with respect to the fourth exemplary link 310, although the reference numbers will increase by 100. A description of many of these elements is abbreviated or even eliminated in the interest of brevity. As shown in FIG. 13, a body 442 of the link 410 forms a T-shape, in which the platform 444 is connected to the first connector 446, the second connector 448, and the third connector 460, where the first connector 446 is oriented 90 degrees relative to the second connector 448, which is oriented 90 degrees from the third connector 460. By comparison to the third exemplary link 210, the fifth exemplary link 410 includes a bridge 450 disposed between the platform 444 and each connector 446, 448, and 460.

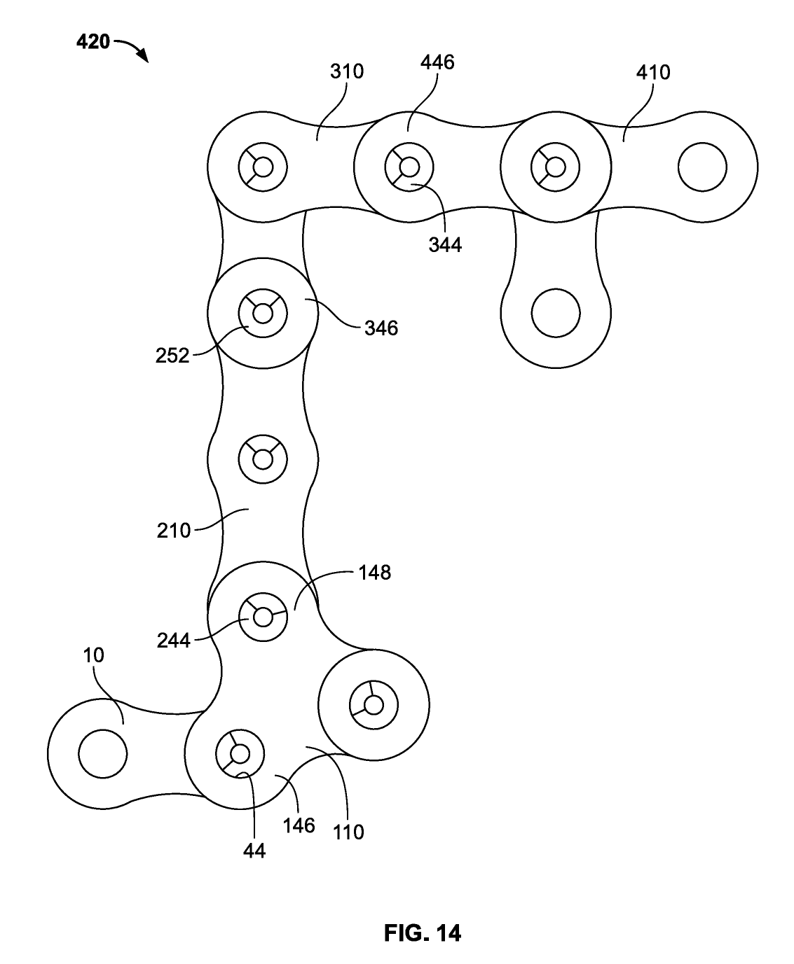

Each of the first, second, third, fourth, and fifth exemplary links 10, 110, 210, 310, and 410 are modular, such that each platform 44, 144, 244, 252, 256, 344, 352, 444 and each connector 46, 146, 148, 346, 446, 448, 460 of each link 10, 110, 210, 310, 410 is configured to couple to a connector 46, 146, 148, 346, 446, 448, 460 and a platform 44, 144, 244, 252, 256, 344, 352, 444, respectively, of a different link. A chain is formed when at least one link 10, 110, 210, 310, 410 overlaps with and locks to another link 10, 110, 210, 310, 410. For example, in FIG. 14, a chain accessory 420 is assembled according to the teachings of the present disclosure. The chain accessory 420 is formed when the platform 44 of the first exemplary link 10 is coupled to the first connector 146 of the second exemplary link 110, in which the second connector 148 is coupled to the first platform 244 of the third exemplary link 210. In this example, the second platform 252 of the third exemplary link 210 is coupled to the connector 346 of the fourth exemplary link 310, where the first platform 344 is coupled to the first connector 446 of the fifth exemplary link 410.

The first, second, third, fourth, and fifth exemplary links 10, 110, 210, 310, 410 are not limited to the shapes and sizes illustrated in the figures. Each of the links 10, 110, 210, 310, 410 and the expandable device 14 may be designed in a variety of shapes and sizes to facilitate rotatably or slidably locking and rotatably or slidably releasing the expandable device 14 to the platform 44, 144, 244, 252, 256, 344, 352, 444 of the link 10, 110, 210, 310, 410. The link 10, 110, 210, 310, 410 advantageously stores at least one expandable device 14 and has the ability to connect with and display a plurality of different expandable devices 14. Each of the links 10, 110, 210, 310, 410 may be used to store multiple expandable devices 14 or for packaging and shipping. The plurality of links 10, 110, 210, 310, 410 may be connected to form a variety of different structures, including a ring or an enclosed loop. The links 10, 110, 210, 310, 410 may be attachable to a surface of a device by fasteners, adhesive, or other grip. The links 10, 110, 210, 310, 410 are preferably made of a durable plastic, such as polyethylene, that may be formed by injection molding, thermoforming, or compression molding, but may instead be formed of any other suitable and durable material including metal, fiberglass, or other similar materials, or any combination of these materials.

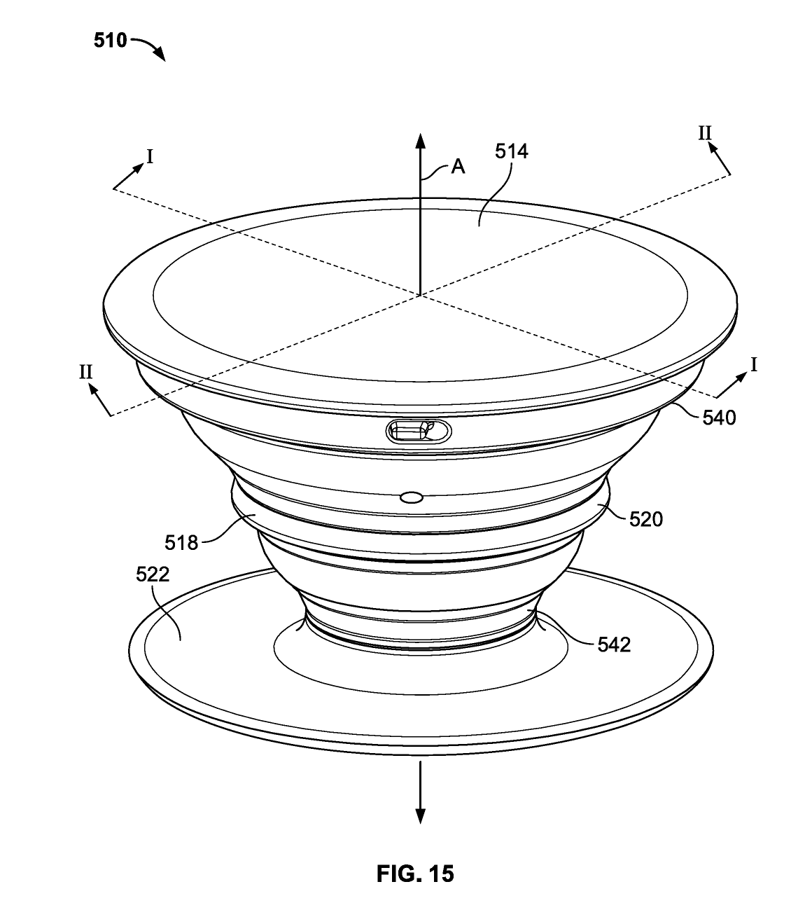

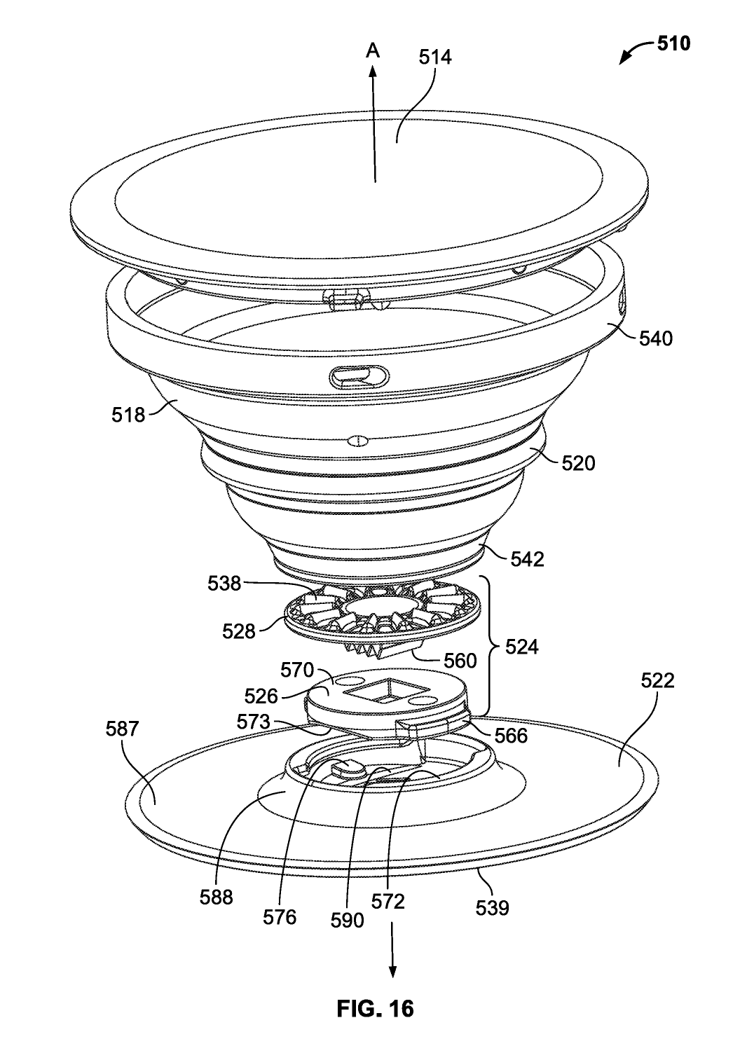

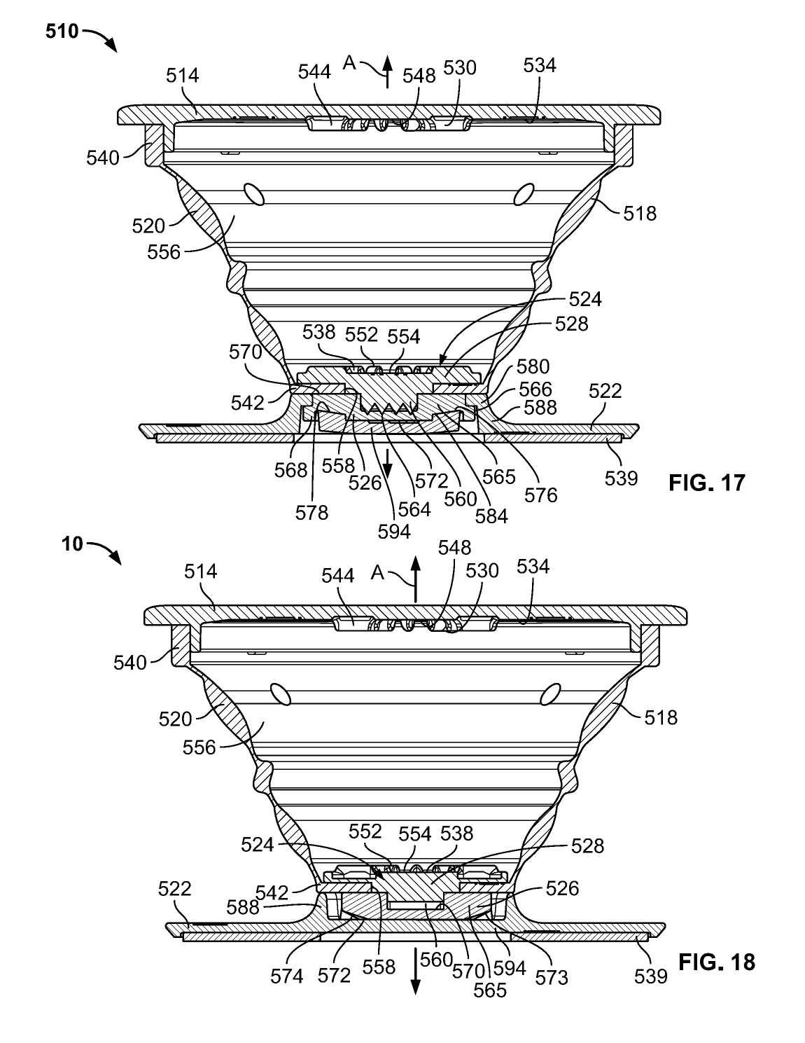

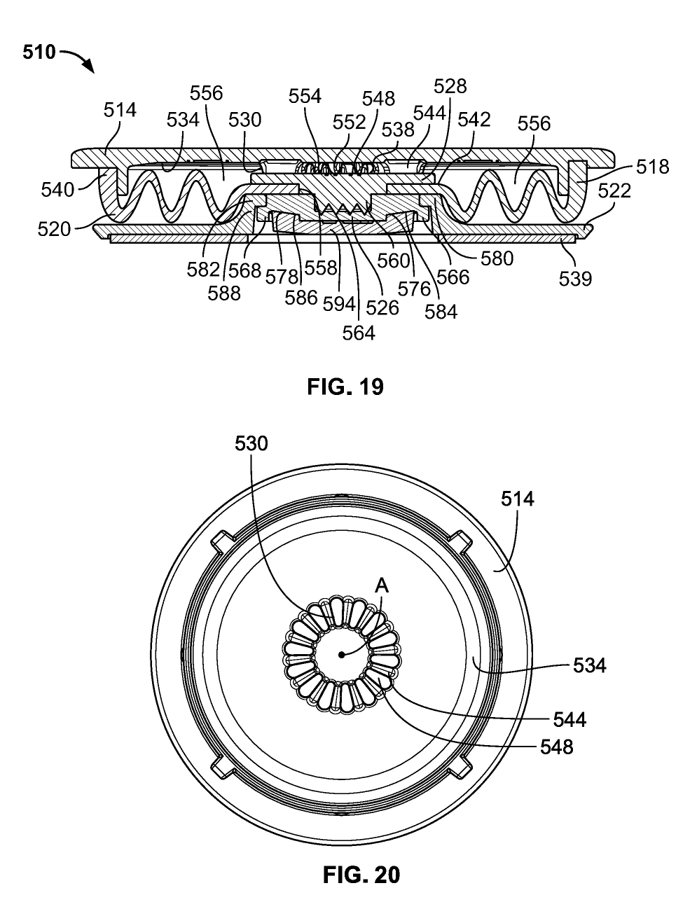

The above exemplary links 10, 110, 210, 310, 410 may include any number of additional features as desired to improve and/or increase its functionality. In FIGS. 15-19, a second exemplary expandable device 510 is constructed in accordance with the teachings of the present disclosure. The expandable device 510 includes a button 514, a body 518 attached to the button 514, and a platform 522 that is attachable to a portable electronic device (not shown), a case for a portable electronic device, or other desired component. The body 518 is movable between an expanded configuration, as shown in FIGS. 15 through 18, and a collapsed configuration, as shown in FIG. 19. A locking device 524, which is hidden from view in FIG. 15 and is shown in FIG. 16, is disposed between the body 518 and the platform 522 to rotatably and releasably couple the body 518 to the platform 522. The locking device 524 is movable between an unlocked configuration, in which the body 518 is removable from the platform 522, and a locked configuration, in which the body 518 is secured to the platform 522. When the body 518 is in the expanded configuration, the body 518 may rotate freely about a longitudinal axis A relative to both the platform 522 and the locking device 524. The body 518 is configured to rotate with the locking device 524, and therefore move the locking device 524 from a locked configuration to an unlocked configuration, for example, only when the body 518 is in the collapsed configuration. As shown in FIGS. 17 through 19, an engaging member 530 carried by an inner surface 534 of the button 514 is configured to engage with a mating surface 538 of the locking device 524 when the device 510 in the collapsed configuration. When the button 514 and body 518 rotate about the longitudinal axis A in the collapsed configuration, the engaging member 530 of the button 514 engages the locking device 524 such that the locking device 524 is rotatable relative to the platform 522 between an unlocked configuration, in which the body 518 is removable from the platform 522, and a locked configuration, in which the body 518 is secured to the platform 522. The locking device 524 also rotates about the axis A relative to the platform 522 from the locked configuration to the unlocked configuration.

As shown in FIG. 16, the locking device 524 includes a hub 526 and a connecting disk 528 rotatably connected to the body 518. In the locked configuration, the body 518 is rotatable relative to the locking device 524 and therefore rotatably coupled to the platform 522 by way of the locking device 524. The platform 522 has a mounting surface 539 that may include an adhesive adapted to attach the platform 522 to the portable device or the case for the portable device. The mounting surface 539 secures the platform 522 relative to the device to facilitate unlocking and locking the locking device 524. The hub 526, the connecting disk 528, the button 514, the body 518, and the platform 522 are aligned relative to the longitudinal axis A when the expandable device 510 is in the locked configuration.

The body 518 can include an accordion-like structure 518 having a collapsible wall 520. The body 518 is movable between the expanded configuration, as shown in FIGS. 15 through 18, and collapsed configuration, as shown in FIG. 19. The body 518 is symmetrical about the longitudinal axis A, and includes a first end 540 distal to the platform 522 and a second end 542 proximate to the platform 522. When the button 514 is attached to the first end 540 of the body 518, the wall 520 of the body 518 and the button 514 define a chamber 556. The body 518 includes an aperture 558 formed in the second end 542 of the body 518 such that the locking device 524 may be partially disposed both internally and externally relative to the body 518. At the second end 542 of the body 518, the chamber 556 has a volume sized to receive the connecting disk 528. The body 518 can be made of a flexible material, such as polyester-based thermoplastic polyurethane elastomer, that may be formed by injection molding, thermoforming, or compression molding, or may be any equivalently functional material suitable for its intended purpose.

As illustrated in FIGS. 17 through 19, the connecting disk 528 of the locking device 524 carried by the second end 542 of the body 518 and is disposed in the chamber 556 of the body 518 adjacent to the second end 542. In this configuration, the mating surface 538 of the connecting disk 528 faces the inner surface 534 of the button 514, and a second mating surface 560 extends through the aperture 558 of the second end 542 of the body 518 for coupling to the hub 526. The connecting disk 528 is disposed within the body 518 and is rotatable relative to the body 518. The connecting disk 528 rotates with the body 518 when the button 514 is attached to the first end 540 of the body 518 and engages with the first mating surface 538 of the connecting disk 528.

The engaging member 530 of the button 514 is particularly suited to connect with the mating surface 538 of the connecting disk 528. As such, locking device 524 of the device 510 is beneficially constructed so that the body 518 does not easily detach from the platform 522 when the device 510 is in use. The button 514 of the device 510 acts as a key to unlock or lock the body 518 from or to the platform 522 when the button 514 engages the locking device 524.

As shown in FIG. 19, the engaging member 530 of the button 514 and the first mating surface 538 of the locking device 524 are arranged so that the engaging member 530 and the first mating surface 538 interlock (e.g., mesh, overlap, engage, mate, couple) when the inner surface 534 of the button 514 is adjacent to the mating surface 538. The inner surface 534 of the button 514 is shown in greater detail in FIG. 20. The engaging member 530 includes a plurality of protrusions 544 (e.g., teeth, ribs, studs, pegs, etc.) separated by a plurality of spaces 548 (e.g., grooves, notches, dimples, etc.), which may be arranged in a predetermined pattern or configuration that corresponds to the mating surface 538 of the connecting disk 528. In this example, the engaging member 530 includes a plurality protruding teeth 544 evenly spaced by the plurality of openings or grooves 548 in the shape of a ring. The engaging member 530 is disposed about the longitudinal axis A, and is symmetrical such that the button 514 may easily mesh with the first mating surface 538 of the connecting disk 528.

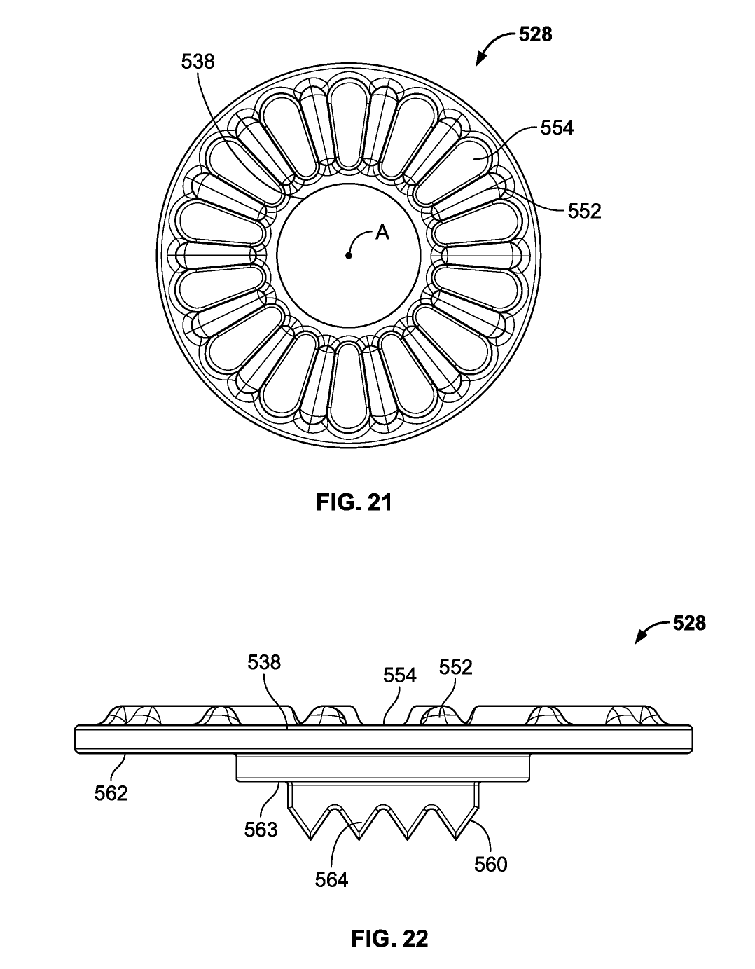

FIG. 21 shows the mating surface 538 of the connecting disk 528 is arranged in a pattern of protruding teeth 552 (e.g., protrusions, ribs, studs, pegs, etc.), which are evenly spaced by a plurality of grooves 554 (e.g., spaces, notches, dimples, etc.). The first mating surface 538 is symmetrical about the longitudinal axis A such that the button 514 may easily mesh with the first mating surface 538 of the connecting disk 528. Turning back to FIGS. 17 through 19, the plurality of protrusions 552 of the connecting disk 528 are aligned, and sized to fit, within the spaces 548 of the engaging member 530 of the button 514. Likewise, the plurality of grooves 554 are aligned, and sized to receive, the plurality of protrusions 544 of the button 514. Thus, when the body 518 is in the collapsed configuration, the plurality of protrusions 544, 552 of the button 514 and the mating surface 538 of the locking device 524 are interlocked and positioned to engage when the button 514 is rotated about the longitudinal axis A. In another example, the mating surface 538 and the engaging member 530 interlock or otherwise engage via a different locking configuration.

In FIG. 22, the second mating surface 560 of the connecting disk 528 is shown. The second mating surface 560 includes a flat area 562, a protruding portion 563 surrounded by the flat area 562 and extending axially away from the flat area 562 of the disk 528. The flat area 562 is configured to lay flat against an interior surface of the second end 542 of the body 518 and the protruding portion 563 is configured to at least partially extend through the aperture 558 of the body 518. The flat area 562 includes a smooth surface to reduce friction between the disk 528 and the body 518 such that the connecting disk 528 is free to rotate relative to the body 518 when the disk 528 is disposed within the chamber 556. A distal end 564 of the protruding portion 563 includes a plurality of angled tips. The angled tips 564 may be configured to flex, bend, or otherwise deform to mate with the hub 526. Once the protruding portion 563 engages the hub 526, the hub 526 and the connecting disk 528 may be fixed (e.g., welded, fused, etc.) together to move as a unitary locking device 524. Alternatively, the hub 526 and connecting disk 528 can be integrally formed. Unlike the flat area 562, the distal end 564 may be a textured material configured to frictionally engage with the hub 526 so that the connecting disk 528 rotates the hub 526 when the disk 528 and hub 526 are engaged.

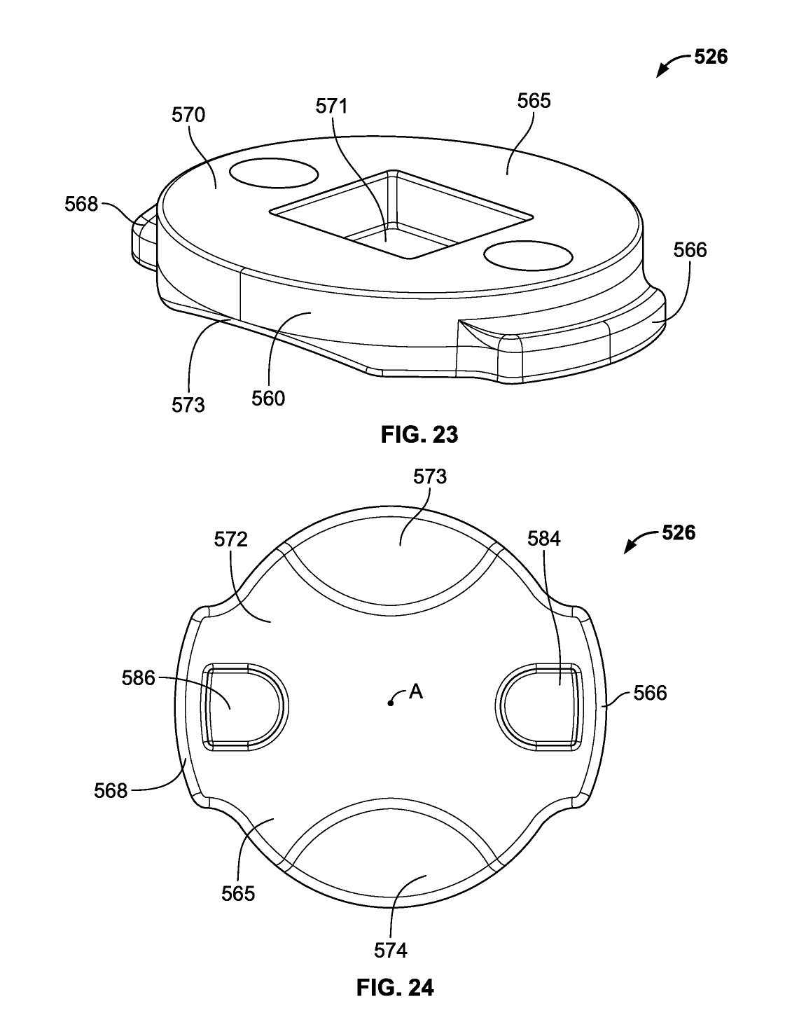

In FIGS. 23 and 24, the hub 526 is shown in greater detail. The hub 526 includes a body 565 and first and second radial wings 566 and 568 that extend outwardly from the body 565. The wings 566 and 568 are disposed on opposing sides of the body 565, and may be a resilient material such that the wings 566 and 568 may deform (e.g., bend, flex) when the wings 566 and 568 engage the platform 522. The body 565 includes a first surface 570 and a second surface 572 opposite the first surface 570. The first surface 570 is configured to mate with the second mating surface 560 of the connecting disk 528. More particularly, an opening 571 formed in the first surface 570 is sized and shaped to receive the protruding portion 563 of the second mating surface 560 of the connecting disk 528. As shown in FIG. 24, the hub 526 includes first and second curved notches or ramps 573, 574 formed in the second surface 572 to facilitate disengagement between the platform 522 and the hub 526 when the locking device 524 rotates relative to the platform 522. Specifically, the notches 573, 574 are formed to slide against protrusions 576, 578 extending from the platform 522 when the locking device 524 rotates a quarter turn (i.e., 90 degrees) about the longitudinal axis A. First and second detents 584, 586 are formed in the second surface 572 of the hub 526 and are shaped to engage with first and second protrusions 576, 578 of the platform 522 when the locking device 524 is in the locked configuration. In another example, the second surface 572 of the body 565 may have only one notch 573 or 574 or no notches. In the case where the hub 526 provide only one notch 573, the portion of the second surface 572 opposite disposed from the notch 573 may be flat or coplanar with the second surface 572. This configuration may facilitate removal of the body 518 from the platform 522. For example, as the locking device 524 is rotated out of locking engagement with the platform 522, the protrusion 576 or 578 of the platform 594 may bias the second surface 572 of the hub 526 upward and away from the platform 522.

The hub 526 and the platform 522 are arranged to rotatably couple to lock the body 518 to the platform 522. The first and second wings 566 and 568 are deformable such that they may deflect from their original position when the wings 566 and 568 engage first and second shelves 580, 582 of the platform 522 as the locking device 524 moves from the unlocked configuration to the locked configuration. The detents 584, 586 formed in the second surface 572 of the hub 526 are configured to engage with the platform 522 in the locked configuration. Specifically, each detent 584, 586 is partially formed in one of the two wings 566, 568. It will be appreciated that the second shelf 582 is substantially similar to the first shelf 580 and the wing 568 is substantially similar to the wing 566, such that any details of the first shelf 580 and the first wing 566 discussed below apply equally to the second shelf 582 and the second wing 568, respectively. In the illustrated expandable device 510, the locking device 524 includes two wings 566 and 568 and the platform 522 includes two shelves 580 and 582 corresponding to the wings 566 and 568 of the locking member 524. However, in another example device, the locking device 524 may have one wing or more than two wings, and the platform 522 may have the same number of corresponding shelves. Likewise, the platform 522 includes two protrusions 576, 578 and the hub 526 includes two detents 584, 586 corresponding to the protrusions 576, 578. However, in another example device, the hub 526 may include one detent or more than two detents, and the platform may have the same number of corresponding protrusions. The hub 526 is preferably made of a durable plastic, such as polyethylene, or a harder plastic, such as polycarbonate, that may be formed by injection molding, thermoforming, or compression molding, but may instead be formed of any other suitable and durable material including thermoplastic polyurethane, metal, fiberglass, or any combination of these materials, or any equivalently functional materials suitable for its intended purpose.

As shown in FIGS. 17 through 19, the hub 526 is coupled to the platform 522 when the locking device is in the locked configuration. The platform 522 includes an outer surface 587 and a collar 588 extending away from the surface 587. The collar 588 defines a cavity 590. The second shelf 582 oppositely disposed from the first shelf 580 is configured to slidably receive one of the wings 566 and 568 of the hub 526. The shelves 580 and 582 are configured to engage one of the wings 566 and 568 of the locking member 524 when the locking member 524 is in the locked configuration. A surface of each shelf 580 and 582 inhibits axial movement of the locking device 524 relative to the platform 522 when the locking device 524 is in the locked configuration. The first and second wings 566 and 568 move out of engagement with the shelves 580 and 582 when the hub 526 is rotated.

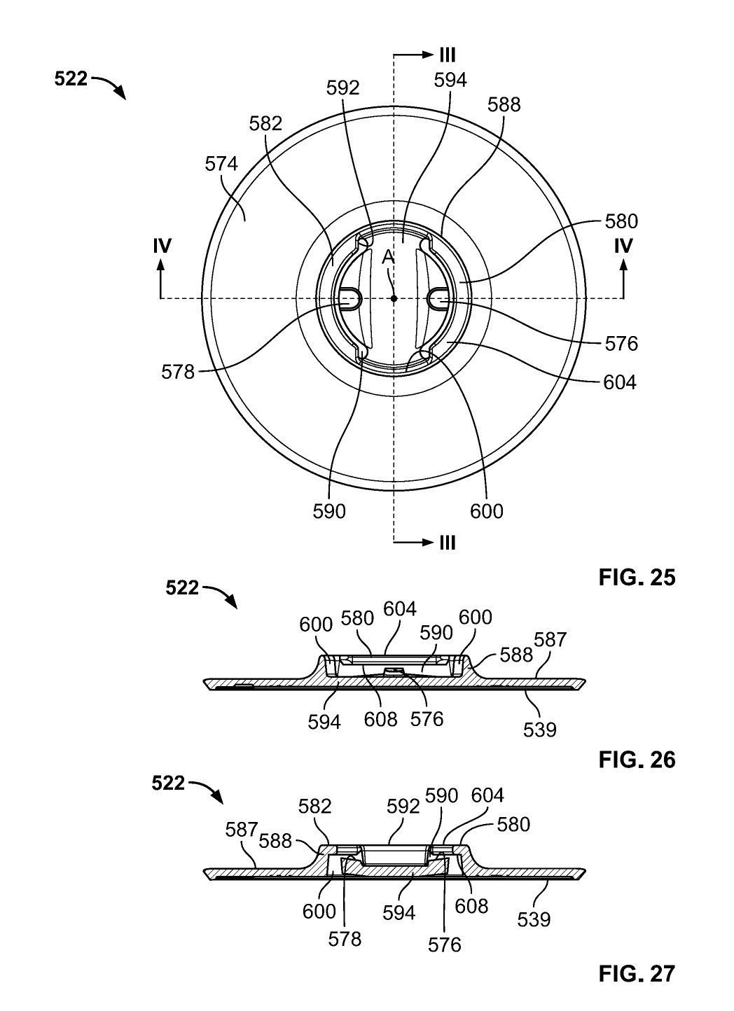

As illustrated in FIGS. 25 through 27, the first exemplary platform 522 includes the first shelf 580 extending radially inwardly from the collar 588 and into a cavity 590 formed in the platform 522. At least a portion of the locking device 524 is adapted to be removably disposed in the cavity of the platform 522 for releasably coupling the body 518 to the platform 522. The cavity 590 is partially defined by a non-circular opening 592, as shown in FIG. 25, and is shaped to receive the first and second wings 566 and 568 of the hub 526. In particular, the opening 592 is defined by first and second opposing shelves 580, 582, and an interior wall 600 of the collar 588. The platform 522 also includes a base 594 that is recessed from the collar 588 and defines a lower boundary of the cavity 590 of the platform 522. The base 594 is connected to an inner wall 600 of the platform 522 such that the base 594 may be co-planar with the mounting surface 539 of the platform 522, as shown in FIG. 26. The base 594 also includes first and second protrusions 576, 578 extending axially into the cavity 590 and spaced radially inwardly relative to the shelves 580, 582, respectively. The base 594 is connected to the inner wall 600 at opposing ends, which are 90 degrees offset from the first and second shelves 580, 582. Above the opposing ends of the base 594, the collar 588 defines a radially recessed inner wall 600, providing a clearance for the hub 526. So configured, the radial wings 566, 568 of the hub 528 may slide into the opening 592 until the radial wings 566, 568 are beneath a reference plane on which the shelves 580, 582 are disposed. The base 594 is disconnected from the inner wall 600 directly below the first and second shelves 580, 582 such that the base 594 may flex downward relative to the shelves 580, 582 when the second surface 572 of the hub 526 engages the base 594.

As shown in FIGS. 26 and 27, the first shelf 580 of the platform 522 includes a first surface 604 that faces the second end 542 of the body 518, and a second surface 608 that engages with one of the first and second wings 566 and 568 of the locking member 524 when the locking member 524 moves from the unlocked configuration to the locked configuration. The platform 522 is preferably made of a durable plastic, such as polyethylene, or a harder plastic, such as polycarbonate, that may be formed by injection molding, thermoforming, or compression molding, but may instead be formed of any other suitable and durable material including thermoplastic polyurethane, metal, fiberglass, or any combination of these materials, or any equivalently functional materials suitable for its intended purpose.

To couple the locking member 524 to the platform 522, the hub 526 is disposed through the opening 592 and into the cavity 590 of the platform 522 such that the locking member 524 is at least partially disposed below first and second shelves 580, 582. The locking member 524 is rotated (e.g., 90 degrees) in either the clockwise or counterclockwise direction about the longitudinal axis A. As the locking member 524 is rotated, the first wing 566 of the hub 526 of the locking member 524 slides against the shelf 580 of the platform 522 until the protrusion 576 of the base 594 snaps into the detent 584 of the second surface 572 of the hub 526. Additionally, the hub 526 may deflect or displace the base 594 until the protrusion 576 and the detent 584 are engaged. The base 594 may be a resilient material such that the base 594 may deform (e.g., bend, flex) when engaged by the hub 526. In one example, the base 594 may bend or flex along a flexible hinge formed in the base 94 extending between opposing sides of the inner wall 600 (i.e., where the base 594 connects to the platform 522. It will be appreciated that the second shelf 582 is substantially similar to the first shelf 580, the second wing 568 is substantially similar to the first wing 566, the second detent 586 is substantially similar to the first detent 584, and the second protrusion 578 is substantially similar to the first protrusion 576, such that any details of the first shelf 580, first wing 566, first detent 584, and the first protrusion 576 discussed above apply equally to the second shelf 582, the second wing 568, the second detent 586, and the second protrusion 578, respectively.

The mating relationships between the button 514 and the connecting disk 528, the connecting disk 528 and the hub 526, and the hub 526 and the platform 522 may be configured to provide any number of different mating engagements. For example, the hub 526 may include one or more protrusions extending from its second surface 572 to couple to one or more detents formed in the base 594 of the platform 522. In another example, the second mating surface 560 of the connecting disk 528 may not extend through the aperture 558 formed in the second end 542 of the body 518, but instead, the first surface 570 of the hub 526 may include a portion that extends into the aperture 558 of the body 518 to couple with the second mating surface 560 of the connecting disk 522. Non-limiting examples of the configuration or mating relationship between the locking member 524 and the platform 522 and/or other components of the device 510 are disclosed in U.S. application Ser. No. 15/864,402, filed Jan. 8, 2018, and U.S. application Ser. No. 15/864,509, filed Jan. 8, 2018, the entire disclosures of which are incorporated herein by reference.

The expandable device 510 may be moved from the locked configuration to the unlocked configuration by overcoming the frictional forces between the mating surfaces of the locking device 524 and the platform 522. Generally speaking, a user of the expandable device 510 may rotate the locking device 524 from the locked configuration to the unlocked configuration by collapsing the expandable device 510 such that the button 514 engages with the connecting disk 528 of the locking device 524, and then by grabbing or grasping the button 514 or body 518 and moving, e.g., rotating or twisting, the button 514 or body 518 a quarter turn (i.e., 90 degrees) in either the clockwise or counterclockwise direction about the longitudinal axis A. The button 514 engages with the locking device 524 to rotate the locking device 524 with the button 514 and body 518. In turn, the connecting disk 528 transfers the rotational motion from the button 514 to rotate the hub 526 of the locking device 524 out of engagement with the platform 522. Once the locking member 524 is in the unlocked configuration, the user may pull the body 518 away and out of the cavity 590 and through the opening 592 of the platform 522 to lock the body 517 to the platform 522.

The device 510 may be assembled by connecting the connecting disk 528 to the second end 542 of the body 518 by disposing the connecting disk 528 into the chamber 556 of the body 518. The second mating surface 560 is coupled to the first surface 570 of the hub 526 such that the hub 526 and the connecting disk 528 form a unitary locking device 524. The body 518 may be coupled to the platform 522 by disposing the hub 526 into the cavity 590 of the platform 522.

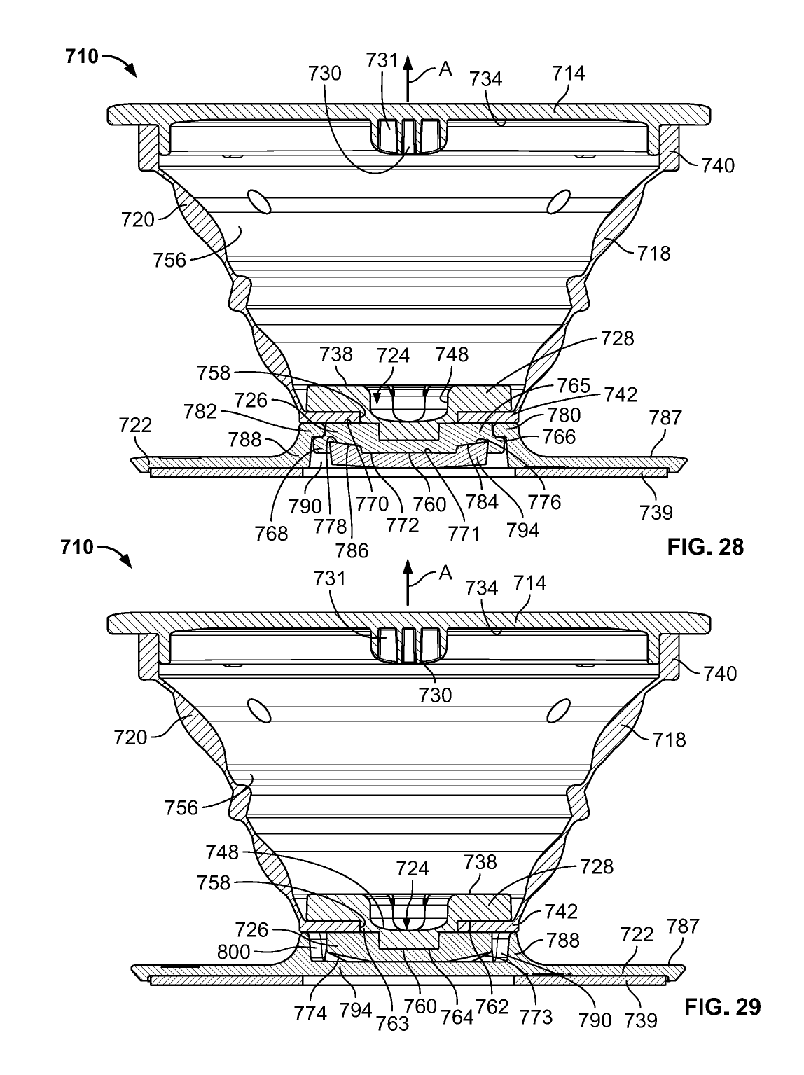

FIGS. 28 and 29 illustrate a second exemplary device 710 constructed in accordance with the teachings of the present disclosure. The second exemplary device 710 is similar to the device 510 of FIGS. 15 through 19. Thus, for ease of reference, and to the extent possible, the same or similar components of the second exemplary device 710 will retain the same reference numbers as outlined above with respect to the first exemplary device 510, although the reference numbers will be increased by 200. However, the second exemplary device 710 is different from the device 510 in the manner described below.

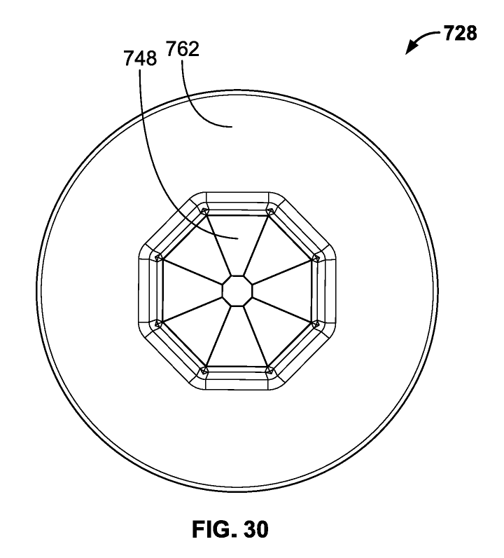

A button 714 of the second exemplary device 710 includes an engaging member 730 having a non-circular cross-sectional shape. The engaging member 730 includes a plurality of sides 731 configured to engage with a corresponding opening 748 or indentation formed in a first mating surface 738 of a locking device 724. As shown in FIG. 30, a connecting disk 728 of the locking device 724 includes the first mating surface 738 having a non-circular shape sized to receive the engaging member 730 of the button 714 when the device 710 is in a collapsed configuration. A body 718, a platform 722, and a hub 726 may be substantially similar to the body 518, platform 522, and hub 526 of the first exemplary device 510 previously described with reference to FIGS. 15 through 27. The mating surface 738 of the locking device 724 and the engaging member 730 of the button 714 may be any number of shapes and structures that facilitate engagement between the locking device 724 and the button 714.

The figures and description provided herein depict and describe preferred examples of an expandable device accessory and modular link for purposes of illustration only. One skilled in the art will readily recognize from the foregoing discussion that alternative examples of the components illustrated herein may be employed without departing from the principles described herein. Thus, upon reading this disclosure, those of skill in the art will appreciate still additional alternative structural and functional designs for expandable devices and modular links with a coupling feature. Thus, while particular examples and applications have been illustrated and described, it is to be understood that the disclosed examples are not limited to the precise construction and components disclosed herein. Various modifications, changes and variations, which will be apparent to those skilled in the art, may be made in the arrangement, operation and details of the methods and components disclosed herein without departing from the spirit and scope defined in the appended claims.

1. An expandable device accessory, the accessory comprising:
a body having a first end and a second end and is movable between an expanded configuration and a collapsed configuration;
a button coupled to the first end of the body; and
a link comprising a first portion and a second portion, the first portion being a platform having an opening sized to receive the second end of the body;
wherein at least the first portion and the second portion of the link is adapted to removably couple to a different link.

2. The accessory of claim 1, wherein the second portion of the link is a connector adapted to removably couple to a platform of a different link, the connector having an aperture sized to receive a portion of the platform of the different link.

3. The accessory of claim 1, further comprising a collar projecting from a surface of the platform, the collar defining the opening of the platform.

4. The accessory of claim 3, wherein the collar is sized to extend into an aperture of a connector of a different link.

5. The accessory of claim 1, further comprising a bridge connecting the first portion and the second portion, the bridge defining a curved surface adapted to fit against a curved surface of a different link.

6. The accessory of claim 1, wherein the second portion of the link is a second platform comprising a collar and an opening sized to receive the second end of the body.

7. The accessory of claim 1, further comprising a locking member attached to the second end of the body, the locking member removably coupled to the opening of the platform.

8. The accessory of claim 7, wherein the locking member slidably couples to the opening of the platform.

9. The accessory of claim 7, wherein the locking member rotatably couples to the opening of the platform.

10. The accessory of claim 1, further comprising:
a second link comprising a first portion and a second portion, the first portion being a platform having an opening sized to receive the second end of the body;
wherein the first portion of the second link removably couples to the platform of the link.

11. The accessory of claim 10, wherein the second link is identical to the link.

12. The accessory of claim 1, wherein a first surface of the first portion lies on a first plane and a first surface of the second portion lies on a second plane different from the first plane.

13. A chain for storing an expandable device of a portable electronic device, the chain comprising:
a first link comprising a body arranged to couple to an expandable device, the body including a collar extending from a surface of the body; and
a second link removably coupled to the body of the first link and including a body defining an aperture sized to receive the collar of the first link, the second link coupled to the body of the first link when the collar of the first link extends through the aperture of the second link;
wherein the first link rotates relative to the second link when the first link is coupled to the second link.

14. The chain of claim 13, wherein the first link includes a second collar extending from the surface of the body.

15. The chain of claim 13, wherein the body of the first link includes an aperture sized to receive a collar of a different link.

16. The chain of claim 13, wherein the body of the first link has a figure-eight shape.

17. The chain of claim 13, wherein the body of the first link is triangular.

18. The chain of claim 13, wherein the body of the first link is L-shaped.

19. The chain of claim 13, wherein the body of the first link has a T-shape.

20. The chain of claim 13, wherein the first link is identical to the second link.

21. A chain accessory for holding expandable devices, the accessory comprising:
a first link comprising a platform, a connector, and a bridge connecting the connector and the platform, the platform including a top surface, a bottom surface, and a collar extending away from the top surface; and
a second link comprising a platform, a connector, and a bridge connecting the connector and the platform, the connector of the second link including an aperture sized to receive the collar of the platform of the first link;
wherein the first link is coupled to the second link when the collar of the first link is disposed in the aperture of the connector of the second link.

22. The accessory of claim 21, further comprising a third link having a platform, wherein the platform of the third link is coupled to the connector of the first link.

23. The accessory of claim 21, wherein the first link includes a second connector sized to receive a collar of the platform of the second link.

24. The accessory of claim 21, wherein the first link includes a second platform adapted to couple to the connector of the second link.

25. The accessory of claim 21, wherein the first link and the second link couple by snap-fit connection.

26. The accessory of claim 21, wherein the first link and the second link couple by interference fit.

27. The accessory of claim 21, wherein the first link and the second link are identical.
